(19) United States
(12) Patent Application Publication
(10) Pub. No.: US 2004/0065528 A1
(43) Pub. Date: Apr. 8, 2004

(54) Wet paper web transfer belt

(76) Inventor: Kenji Inoue, Tokyo (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/664,628

(22) Filed: Sep. 19, 2003

(30) Foreign Application Priority Data
Sep. 30, 2002 (JP) 286420/2002

(51) Int. Cl. B65G 13/02

(52) U.S. Cl. 198/699.1

(57) ABSTRACT

In a wet paper web transfer belt comprising a base body, a wet paper web side layer, and a machine side layer, the wet paper web side layer is formed of a high molecular weight elastic section having fibers protruding from its surface. The protruding fibers hold water from a wet paper web and therefore, the transfer of a wet paper web by attachment to the transfer belt, and the smoothness of removal of the wet paper web from the transfer belt when the web is transferred to the next stage of the papermaking process, are both improved without decreasing the durability of the transfer belt.

### FIELD OF THE INVENTION

This invention relates to papermaking, and particular to improvements in a wet paper web transfer belt for transferring a wet paper web at high speed.

### BACKGROUND OF THE INVENTION

In recent years, the closed draw papermaking machine has been developed for increasing the operating speed of a papermaking machine. The closed draw papermaking machine lacks an open draw, that is, a part where a wet paper web is transferred without being supported. The closed draw structure avoids various problems encountered in the operation of an open draw machine, such as running out of paper, and consequently provides for higher speed operation and greater productivity.

A typical closed draw papermaking machine is illustrated in FIG. 1. A wet paper web WW, shown by a broken line, is transferred from right to left, being supported by press felts PF1 and PF2, a wet paper web transfer belt TB, and a dryer fabric DF. These press felts PF1 and PF2, the transfer belt TB, and the dryer fabric DF, are endless belts, supported by guide rollers GR.

The machine includes a press roll PR, a shoe PS, a shoe press belt SB, and a suction roll SR, all having structures which are generally known. The shoe PS has a concave shape which conforms to the press roll PR. The shoe PS, the shoe press belt SB, and the press roll PR form the press part PP of the machine.

In the operation of the closed draw papermaking machine, the wet paper web WW, which is continuous, successively passes through a wire part and a first press part which are not shown, and is transferred from the press felt PF1 to the press felt PF2. The press felt PF2 transfers the wet paper web to the press part PP. The wet paper web WW, pinched between the press felt PF2 and the wet paper web transfer belt TB in the press part PP, is compressed by the shoe PS and the press roll PR, having the shoe press belt SB therebetween

The press felt PF2 has high water permeability and the wet paper web transfer belt TB has low water permeability. Therefore, water in the wet paper web WW moves to the press felt PF2 at the press part PP. Immediately after the press felt PF2, the wet paper web WW, and the wet paper web transfer belt TB, move out of the press part PP, their volume immediately expands as the pressure applied to them is suddenly released. This expansion, and the capillary action of the pulp fiber of the wet paper web WW, cause a phenomenon known as “rewetting,” wherein part of water in the press felt PF2 is returned to the wet paper web WW.

However, since the wet paper web transfer belt TB has very low permeability, it does not hold water. Therefore, the rewetting phenomenon does not occur in the belt TB and thus, the wet paper web transfer belt TB contributes to improvement in the efficiency of water removal from the wet paper web. The wet paper web WW moving out of the press part PP is transferred by belt TB to the suction roll SR, where it is transferred by suction to the dryer fabric DS for drying.

The transfer belt TB is required to perform two functions. It must transfer the wet paper web WW, while attached to the transfer belt TB, after the belt TB exits the press part PP, and it must allow the wet paper web to be removed smoothly from transfer belt TB as the wet paper web WW is transferred to the next process, in this case, the drying process. Various transfer belt structures have been proposed for carrying out these two functions. For example, in one transfer belt structure depicted in U.S. Pat. No. 4,529,643, a needle felt, comprising a woven fabric and a batt fiber intertwiningly integrated with the woven fabric by needle punching, is impregnated with a high molecular weight elastic material and cured.

In another structure, shown in FIG. 2 and described in U.S. Pat. No. 4,500,588, a wet paper web transfer belt TB10 has a woven fabric 31, a batt fiber 41 intertwiningly integrated with the woven fabric 31 by needle punching, and a high molecular weight elastic section 51 provided on the batt fiber 41 as the basic structure. This wet paper web transfer belt TB10 has a wet paper web side layer TB11 and a machine side layer TB12, and is characterized by the fact that the surface layer of the wet paper web side layer TB11 does not have a high molecular weight elastic section 51, and comprises only a batt fiber.

Still another wet paper web transfer belt TB20, shown in FIG. 3, is described in Japanese Patent No. 3264461 (at page 10-13, and FIG. 4). This transfer belt comprises a woven fabric 31, a high molecular weight elastic section 51 formed on one side of the woven fabric, and a batt layer 41 formed on the other side of the woven fabric. Therefore, a wet paper web side layer TB21 of the transfer belt TB20 is formed by the high molecular weight elastic section 51 and a machine side layer TB22 is formed by the batt layer 41.

The surface of the wet paper web side layer TB21 is roughened, for example by grinding. The ten-point average roughness surface roughness Rz, according to JIS-B0601, is in the range of 0 to 20 microns in the press part, and is in the range of 2 to 80 microns after the belt moves out of the press part.

In the operation of the belt of FIG. 3, the ten-point average roughness Rz is maintained in the range of 0 to 20 microns for a short time after the belt moves out of the press part. In other words, the surface of the wet paper web side layer TB21 is relatively smooth at this point. Therefore, a thin water film may be formed between the wet paper web and the surface of the wet paper web side layer TB21. The wet paper web is suitably attached to the surface of the wet paper web side layer TB21 by adhesion due to the thin water film. As the wet paper web transfer belt TB20 travels further, the surface roughness of its wet paper web side layer increases to a ten-point average roughness Rz in the range of 2 to 80 microns. As a result, the thin water film between the wet paper web and the surface of the wet paper web side layer TB21 is broken, and the adhesion between the transfer belt and the wet paper web is reduced. Therefore, transfer of the wet paper web to the next stage becomes easy. The wet paper web transfer belt TB20 shown in FIG. 3 suitably performs the dual function necessary for proper operation of a wet paper web transfer belt.

Another wet paper web transfer belt structure, shown in FIG. 4, is described in Unexamined Japanese Patent Publication No. 89990/2001. A wet paper web side layer TB31, of the belt TB30, comprises a fiber body 41 and a high molecular weight elastic section 51. Either this fiber body 41 or the high molecular weight elastic section 51 is hydrophobic and the other is hydrophilic. This technology has an excellent ability to break the water film formed between the wet paper web and the wet paper web transfer belt.

In the case of the wet paper web transfer belt of U.S. Pat. No. 4,529,643, voids between batt fibers are not always filled with the high molecular weight elastic material. On the other hand, in the case of the structure of U.S. Pat. No. 4,500,588, the wet paper web side layer is formed only by the batt layer. In both of these cases, the wet paper web side layer is formed by the batt layer. Therefore, a large amount of water is absorbed in the wet paper web side layer and some rewetting can occur. In addition, smooth transfer of a wet paper web from the transfer belt to the next stage of the papermaking process does not always take place.

In the wet paper web transfer belt of Japanese patent 3264461, the roughness of the surface of a high molecular weight elastic section decreases when the belt is compressed, and the surface returns to its previous level of roughness after a time. However, wear of the wet paper web side layer causes deterioration in the ability of the surface roughness of the belt to change, and therefore, the belt is not reliable for long-term use.

In addition, Japanese Patent Publication No. 89990/2001 does not disclose a structure for enhancing adhesion between the wet paper web and the wet paper web transfer belt.

In view of the above problems, it is an object of this invention to provide a wet paper web transfer belt which may be used over a long term, while fully realizing good adhesion of a wet paper web to the transfer belt and also smooth removal of the wet paper web from the transfer belt when the wet paper web is transferred to a next stage in the papermaking process.

### SUMMARY OF THE INVENTION

The invention solved the above-mentioned problems by providing a wet paper web transfer belt used in a press part of a closed draw papermaking machine, comprising a base body, a wet paper web side layer and a machine side layer, in which fibers protrude from the surface of the wet paper web side layer. According to the invention, the fibers protruding from the surface of a wet paper web side layer hold water from the wet paper web. Attachment of the wet paper web to the transfer belt, and smooth removal of the wet web from the transfer belt when the wet web is transferred to a next stage in the papermaking process, may be realized over a long time.

The average length of the protruding parts of the fibers is preferably between 0.01 and 3 mm, and the average density of the protruding parts of the fibers is in the range of 10 to 500,000 fibers/cm².

The wet paper web side layer preferably has a high molecular weight elastic section. If the fibers are embedded in the high molecular weight elastic section the protruding parts of the fibers are formed by processing the surface of the high molecular weight elastic section. Alternatively, a belt-shaped body may be placed on the high molecular weight elastic section and fibers of the belt-shaped body may be made to protrude by processing the surface of the belt-shaped body.

### BRIEF DESCRIPTION OF THE DRAWINGS

FIG. 1 is a schematic view of a typical closed draw papermaking machine;

FIG. 2 is a cross-sectional view of a conventional wet paper web transfer belt;

FIG. 3 is a cross-sectional view of another conventional wet paper web transfer belt;

FIG. 4 is a cross-sectional view of still another conventional wet paper web transfer belt;

FIG. 5 is a cross-sectional view taken in the cross machine direction, schematically showing a wet paper web transfer belt according to the invention;

FIG. 6 is cross-sectional view illustrating the function of a wet paper web transfer belt according to the invention;

FIG. 7 is another cross-sectional view illustrating the function of a wet paper web transfer belt according to the invention;

FIG. 8 is a cross-sectional view of an embodiment of a wet paper web transfer belt according to the invention;

FIG. 9 is a cross-sectional view of a wet paper web transfer belt in accordance with another embodiment of the invention;

FIG. 10 is a cross-sectional view of a wet paper web transfer belt in accordance with still another embodiment of the invention;

FIG. 11 is an electron microscope photograph showing the surface of the wet paper web side layer of a wet paper web transfer belt according to the invention;

FIG. 12 is a schematic view of an apparatus for evaluating performance of examples of a wet paper web transfer belt;

FIG. 13 is a chart showing results of evaluations conducted using an apparatus of FIG. 12;

FIG. 14 is a schematic view explaining the cutting directions of samples which were used in tests; and

FIG. 15 is a schematic view explaining the manufacturing method used to produce the transfer belts of Examples 5 and 6.

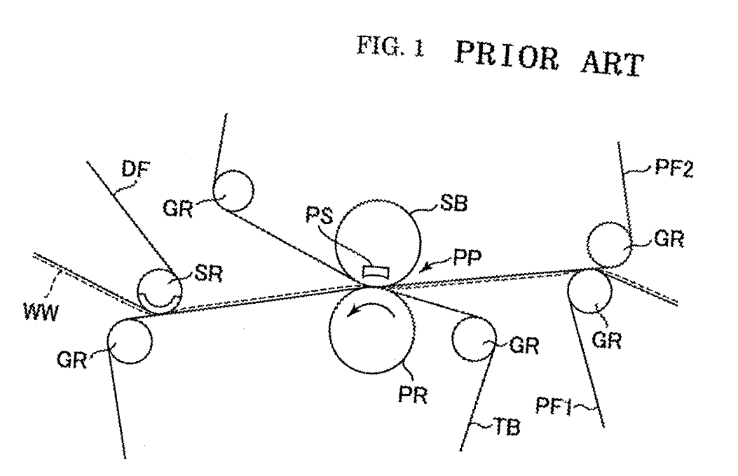

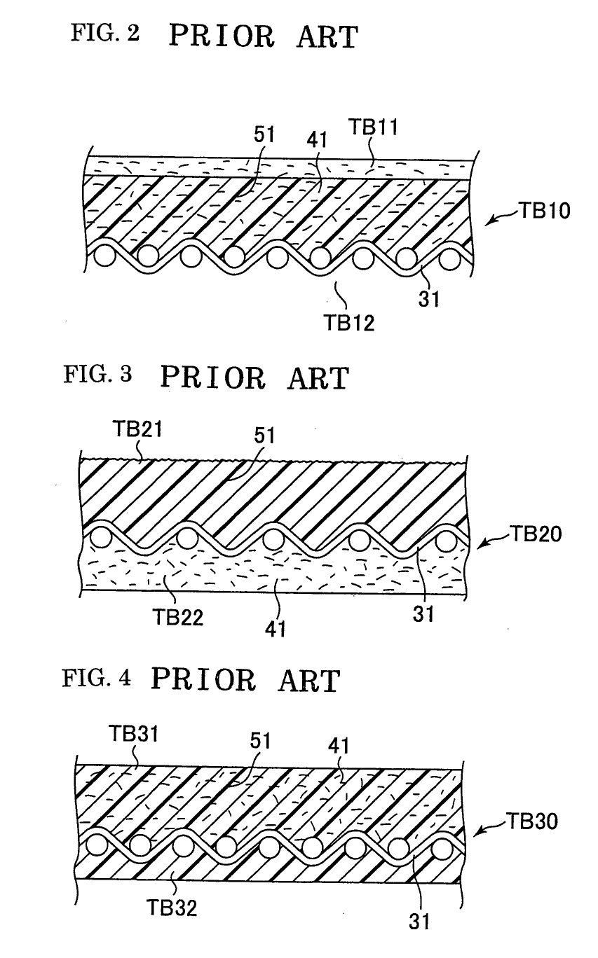

### DETAILED DESCRIPTION OF THE PREFERRED EMBODIMENTS

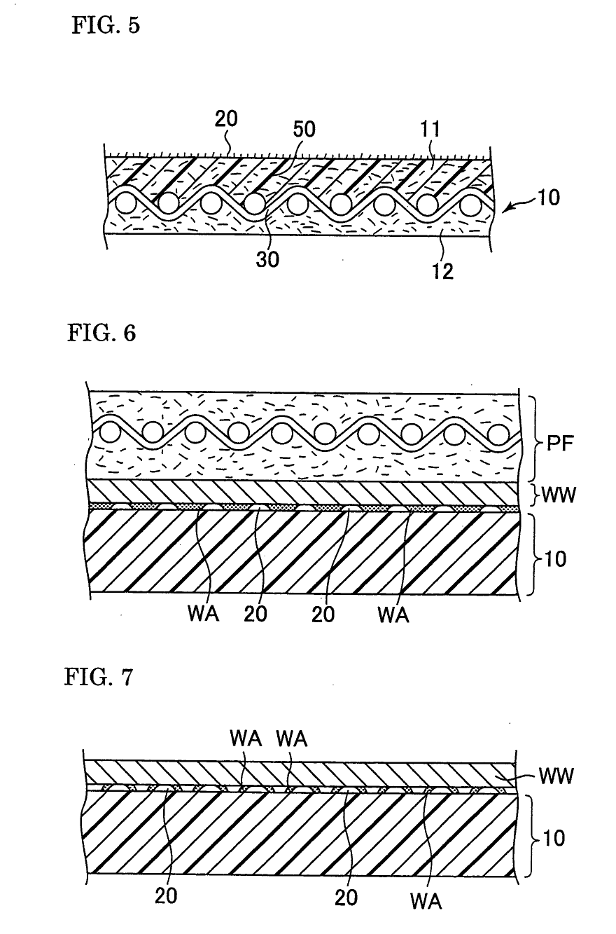

Embodiments of the invention will be explained referring to FIGS. 5-10. In FIG. 5, a wet paper web transfer belt 10 comprises a base body 30, a wet paper web side layer 11 and a machine side layer 12. The wet paper web side layer 11 is formed from a high molecular weight elastic material 50. Fibers, in the form of a fiber body 20, protrude from the wet paper web-contacting surface of the molecular weight elastic section 50.

FIG. 6 is a cross-sectional view of the elements moving through the press part of a papermaking machine, where a press felt PF, a wet paper web WW, and a wet paper web transfer belt 10 are in stacked relationship with one another. The wet paper web WW is pinched between the press felt PF, and the wet paper web transfer belt 10. Most of water from the wet paper web moves into the press felt PF, since the permeability of the wet paper web transfer belt 10 is either zero or very low. Water WA from the wet paper web WW fills the spaces between wet paper web WW and the wet paper web transfer belt 10.

FIG. 7 shows the wet paper web WW and the transfer belt 10 immediately after the press felt PF, the wet paper web WW, and the wet paper web transfer belt 10 move out of the press part of the machine and the press felt is separated from the wet paper web. After these elements move out of the press part, the water between the wet paper web WW and the wet paper web transfer belt 10 is drawn into fiber body by the surface tension of the protruding fibers. The water held in the fiber body 20 causes the wet paper web WW to be attached to the wet transfer belt 10. If the fiber body 20 is concentrated, water is concentrated by capillary force generated between the fibers as well as by the surface tension of the individual fibers.

The wet paper web transfer belt 10 and the wet paper web WW continue to travel together, and the wet paper web WW is transferred to the next stage, usually to a drying fabric in a drying stage. As explained above, water between the wet paper web transfer belt 10 and the wet paper web WW is held by the fiber body 20. However, since this water is not in the form of a film, which generates strong adhesion, the wet paper web WW is transferred smoothly to the next stage.

It was determined from the results of tests that excellent effects may be obtained when average length of the fibers 20 protruding from the surface of the high molecular weight elastic section 50 is between 0.01 and 3 mm.

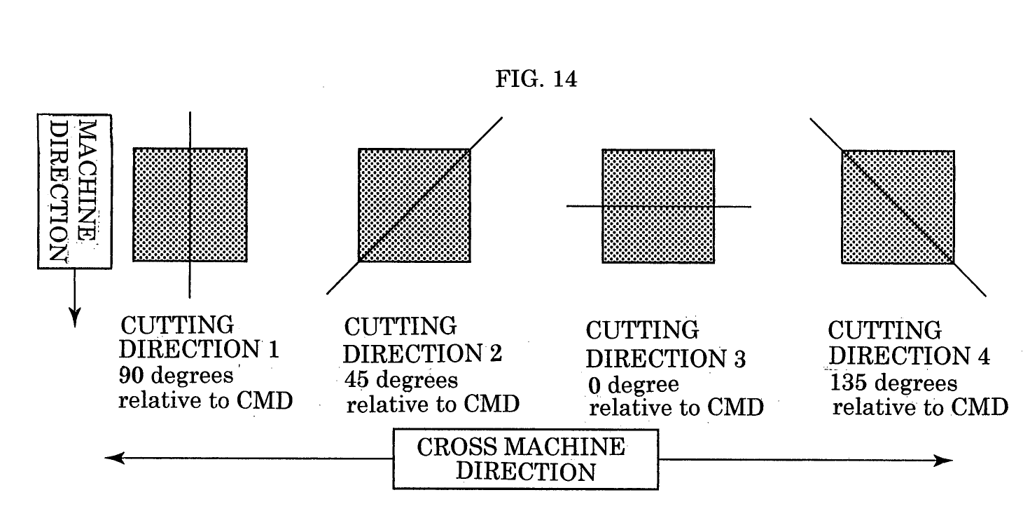

Measurement of the average length of the fibers of the fiber body protruding from the surface is conducted as follows. First, samples are cut from the transfer belt in several different directions relative to the cross machine direction or machine direction of the papermaking machine. At a minimum, the belt is cut in four directions, as shown in FIG. 14, to minimize the effects of unevenness caused by an orientation of the fibers. At least three sets of samples cut in four directions are prepared so that the total number of samples for measurement is at least 12.

An electron microscope or optical microscope is adjusted to focus on the cross section, and a photograph is taken. Any fiber, the ends of the projecting part of which are in the photograph, can be used as a measuring object. Fiber length is measured based on a predetermined standard. The predetermined standard, may be, for example to measure every measuring object fiber sequentially, starting from a left side of the photograph, or to measure every other measuring object fiber, starting from the left side of a photograph. At least ten fibers should be measured in each sample. The same predetermined standard, and number of measurement per sample, is applied to all the samples. Thus, the number of measured fibers is at least 120 (12 (number of samples)×10 (number of fibers in one sample)=120). The average length of the protruding parts of the fibers of a wet paper web transfer belt is obtained by calculating the arithmetic average of the lengths obtained by these measurements.

An electron microscope has some focal depth, and in the case of an electron microscope, light does not reflect back even in the case of a transparent, high molecular weight, material. Therefore, the number of fibers may be counted except when fibers are completely overlapped. On the other hand, an optical microscope has a shallow focal depth, and only the surface at which the optical microscope is focused can be clearly seen. Accordingly some difficulty was encountered in distinguishing fibers from a traces due to grinding.

It was also determined that, when the fibers of a fiber body 20 are excessively long, the water retention property of the fibers becomes excessively high, and this caused rewetting, that is, movement of water held by the long fibers back to the wet paper web after a belt moves out of the press part of the papermaking machine. In addition, it was also determined that, when the fibers are excessively long, the surface smoothness of wet paper web side layer 11 became worse than that of the wet paper web contacting surface of a press felt PF. Since a wet paper web which moves out of the press part of a papermaking machine has a tendency to remain attached to the smoother surface, the wet paper web would remain attached to the press felt PF.

On the other hand, when the fibers are excessively short, the water retention of the fiber body 20 is low, and a thin water film is formed between the wet paper web WW and the transfer belt 10. In this case, difficulties are encountered in removing the wet paper web WW from the wet paper web transfer belt 10 when the wet paper web is transferred to the next stage in the papermaking process.

In addition, it was determined that the fiber body 20 exhibited the best performance when its average density (number of fibers per unit area) on the surface of a wet paper web side layer of the transfer belt is in the range of 10 to 500,000 pcs/cm².

Measurement of average density of the fibers body is carried out using an electron or optical microscope. A photograph of the surface of the wet paper web side layer is taken, and the number of fibers is counted. FIG.11 is an electron microscope photograph of a portion of the surface of a wet paper web side layer 11 of a wet paper web transfer belt according to the invention. The area of the surface in which there are 100 fibers is measured. These measurements are conducted at ten locations and the average area is determined. The average density is the reciprocal of the average area.

When the density of the fiber body 20 is excessively small, a thin water film formed between the wet paper web WW and the wet paper web transfer belt, causes the wet paper web WW to be strongly attached to the transfer belt as the belt moves which was out of the press part of the papermaking machine. Consequently, difficulties were encountered in removing the wet paper web WW from the transfer belt when the wet paper web WW is to be transferred to the next stage in the papermaking process. On the other hand, when the density of a fiber body 20 is excessively large, its water retention became excessively high, and this caused rewetting problems.

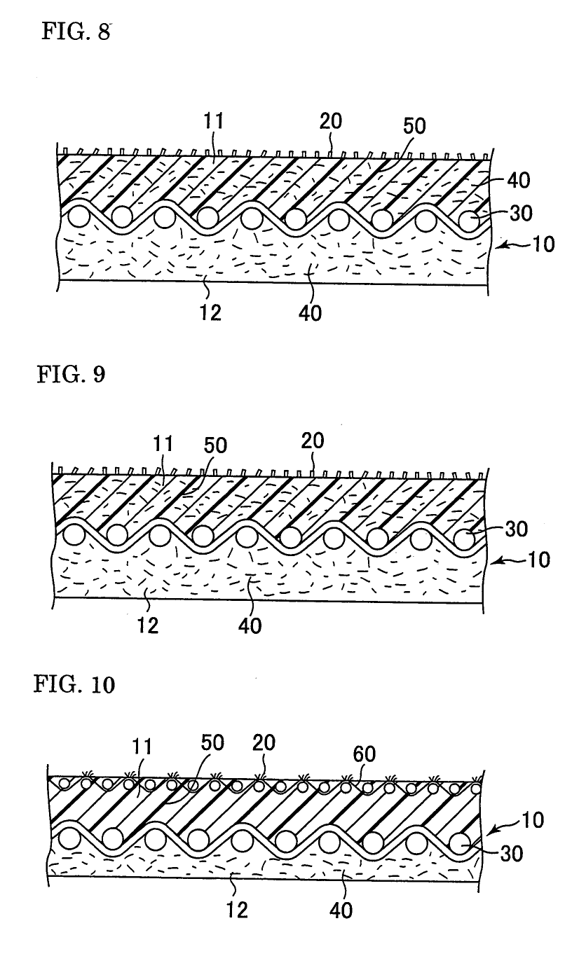

Specific structures of wet paper web transfer belts according to the invention will be described, referring to FIGS. 8-10. In FIG. 8, a wet paper web transfer belt 10 comprises a base body 30, a wet paper web side layer 11, and a machine side layer 12. The machine side layer 12 comprises a batt layer 40 comprising batt fibers intertwiningly integrated with the machine side of the base body 30. The wet paper web side layer 11 comprises a high molecular weight elastic section 50 formed by impregnating a high molecular weight elastic material into a batt layer 40 comprising batt fiber which are intertwiningly integrated with the wet paper web side of the base body 30 and curing the elastic material. Fibers of a fiber body 20 protrude from the surface of the high molecular weight elastic section 50. The fiber body 20 may be obtained by grinding the surface of the wet paper web side layer 11 with sandpaper, whetstone, or the like, and thereby exposing a part of the batt layer 40.

In FIG. 9, wet paper web transfer belt 10 comprises a base body 30, a wet paper web side layer 11 and a machine side layer 12. The wet paper web side layer 11 comprises a high molecular weight elastic section 50 formed on the wet paper web side of the base body 30, and the machine side layer 12 comprises a batt layer 40 comprising a batt fiber intertwiningly integrated with the machine side of the base body 30. Fibers of a fiber body 20 protrude from the surface of the high molecular weight elastic section 50. In this example, the fibers of the fiber body 20 are dispersed by mixing them into the high molecular weight elastic material when the high molecular weight elastic material is in a liquid state during the formation of section 50. After the high molecular weight elastic material in which the fiber body 20 is mixed is cured, the fibers are exposed by grinding the surface of section 50 with sandpaper, a whetstone, or the like.

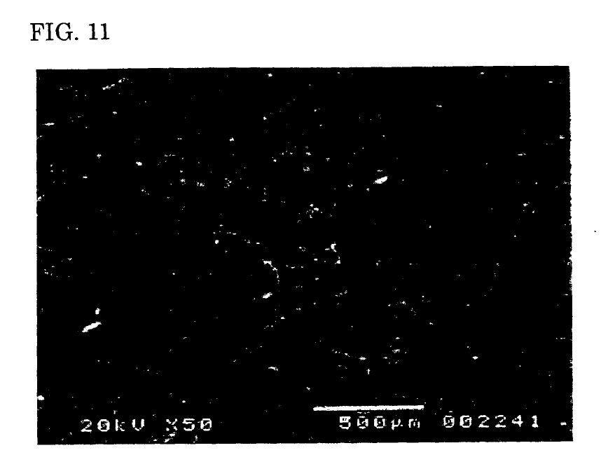

In the embodiment depicted in FIG. 10, a wet paper web transfer belt comprises a base body 30, a wet paper web side layer 11 and a machine side layer 12. The wet paper web side layer 11 comprises a high molecular weight elastic section 50 which is formed on the wet paper web side of the base body 30, and the machine side layer 12 comprises a batt layer 40 comprising a batt fiber bonded to a machine side of the base body 30. In this case, a belt-shaped fiber body 20 is provided-on the outer surface of the high molecular weight elastic section 50. This belt-shaped fiber body has fibers which protrude from the surface of the wet paper web side layer 11. To produce the protruding fibers, a woven fabric 60 is provided on the surface of the high molecular weight elastic section after the elastic section 50 is formed to a desired height. Liquid, high molecular weight, elastic material is impregnated into the woven fabric 60 until its surface is coated. The liquid, high molecular weight, elastic material is cured, and then the fibers are caused to protrude by grinding the surface of the wet paper web side layer 11 with sandpaper, a whetstone, or the like.

When multifilament yarns are provided in the surface of the woven fabric 60, it is easy to expose many fibers by grinding the surface since the multifilament yarns are cut. Alternatively a structure similar to that shown in FIG. 10, may be produced using a non-woven fabric instead of a woven fabric 60.

In another structure, not shown in the drawings, a part of a base body, corresponding to base body 30 in FIG. 10, is exposed by grinding a high molecular weight elastic section provided on the wet paper web side of the base body, so that a part of the base body becomes the exposed fibers protruding from the surface of the belt on the wet paper web side. In this case, it is desirable to use a base body having sufficient strength. Thus a multi-woven fabric, or overlapping endless woven fabrics, are preferably used.

In each case, the fibers of the fiber body are caused to protrude by grinding the surface of the wet paper web side layer comprising a high molecular weight elastic section. The wet paper web side layer of the wet paper web transfer belt according to the invention contributes to the formation of an excellent paper surface, since it becomes at least as smooth as the wet paper web contacting surface of a press felt.

In the case of a multifilament woven fabric embedded in the surface of the high molecular weight elastic material, as mentioned previously, numerous fibers are exposed because fibers are cut in the grinding process. However, in general, the fibers forming the fiber body should have sufficient strength to resist cutting, so that fibers are not removed by cutting in the process of grinding the high molecular weight elastic material to expose the fibers. It is desirable that the strength of the fibers be 0.8 g/dtex or more.

In addition, it is desirable that fineness of a fiber forming a fiber body 20 be between 0.1 and 150 dtex, since its strength is insufficient when it is excessively thin, and the shape of the fibers is transferred to the surface of the wet paper web when the fibers are excessively thick. Organic fibers such as nylon, polyester, aramid, rayon, wool, cotton, hemp, acrylic, etc., and inorganic fibers such as glass fibers, may be used as the material of the fiber body 20. Water retention properties suitable for a papermaking machine may be obtained by appropriately selecting materials based on their hydrophobic or hydrophilic properties. In addition, modified cross section fibers and hollow fibers may be used to improve the water retention properties of the fiber body.

Various resins, such as thermosetting resins and thermoplastic resins may be used as a material for a high molecular weight elastic section. Optionally, hydrophobic or hydrophilic materials may be used, and fillers may be mixed into the resin.

Ordinarily, a suitable wet paper web transfer belt according to the invention will have no permeability. On the other hand, some papermaking machine may require a transfer belt having permeability. In such a case, a suitable permeable structure may be obtained by reducing the amount of high molecular weight elastic material impregnated into the batt layer in the embodiment of FIG. 8, increasing the amount of grinding, or using a high molecular weight elastic material with open cells. However, even in this case, it is preferable that the permeability of the wet paper web transfer belt be 2 cc/cm²/sec or less. Permeability may be measured by the use of a fragile type testing machine as specified in JIS L 1096, which describes a test method for a general woven fabric.

The base body 30 imparts strength to the wet paper web transfer belt. Although woven fabric, composed of machine direction yarns and cross-machine direction yarns, is shown in FIGS. 8-10, the base body may have various other structures as appropriate. For example, the base body can be composed of machine direction yarns and cross machine direction yarns which are overlapped rather than woven. Alternatively, the base body can be composed of a film, a knitted fabric, or may be in the form of a belt-shaped body having a relatively large width produced by winding a relatively narrow belt-shaped body in a spiral.

In addition, although the machine side layers 12 of the belts shown in FIGS. 8-10 are batt layer, the machine side layer 12 is not limited to this structure and may be formed, for example, of a batt layer 40 impregnated with a high molecular weight elastic material or composed only of a high molecular weight elastic material.

Examples of wet paper web transfer belts according to the invention were produced as follows.

### EXAMPLE 1

Urethane resin was used to coat the inner surface of an endless woven fabric and was impregnated into the woven fabric and laminated over the outer surface of the woven fabric. Nylon pile was scattered over the urethane resin laminated on the outer surface of the woven fabric before curing of the resin. Nylon pile having a thickness of 6 dtex and a fiber length of 3 mm was used. The resin was cured while the nylon pile was slightly buried under the surface of the resin. Then the surface of the cured urethane resin was ground with sandpaper. The average length of the parts of the fibers protruding on the outer surface of the wet paper web side layer was 0.08 mm, and the average density of the fibers of about 3 pcs/cm².

### EXAMPLE 2

The second example was produced using the same process as in Example 1, except that the amount of nylon pile scattered over the urethane resin layer on the outer surface of the woven fabric was doubled. The same nylon pile as that of Example 1, having a thickness of 6 dtex and a fiber length of 3 mm was used. In this case, the average length of a protruding parts of the fibers was 0.07 mm, and the average density of the fibers was about 15 pcs/cm².

### EXAMPLE 3

In this example, a needle felt was obtained by intertwiningly integrating fiber mats respectively with the outer and inner surfaces of an endless woven fabric by needle punching. Fiber mats, each comprising nylon-6 staple fibers with a thickness of 6 dtex were used. The density of the staple fibers was brought to about 0.4 g/cm³ by heat-pressing the needle felt. Urethane resin was impregnated into the needle felt from its outer surface, and impregnated into the middle of the woven fabric, and coated the outer surface of the needle felt. The urethane resin was cured, and its surface was ground using sandpaper. In this example, the average length of the protruding parts of the fibers was 0.08 mm, and the average density of the fibers was about 10,000 pcs/cm².

### EXAMPLE 4

This example was made using the same process as in Example 3, except that the thickness of the staple fibers was 3 dtex. The average length of the protruding parts of the fibers was 0.09 mm, and the average density of the fibers was about 20,000 pcs/cm².

### EXAMPLE 5

A base body composed of woven nylon multifilament yarn was coated with resin, and an uncured resin layer having a thickness of about 0.3 mm was formed on the top of the woven base body. A woven fabric comprising 0.3 dtex fibers of was buried in the resin and thereby integrated with the base body. Thereafter, the resin was cured. After the resin was cured, the resin coating the woven fabric was ground and the woven fabric was exposed. The average length of the protruding parts of the fibers was 0.08 mm, and the average density of the fibers was about 500,000 pcs/cm².

### EXAMPLE 6

This example was produced using the same process as in Example 5, except that the amount of grinding was adjusted so that more fibers protruded. In this case, the average length of the protruding parts of the fibers was 0.09 mm, and the average density of the fibers was about 600,000 pcs/cm².

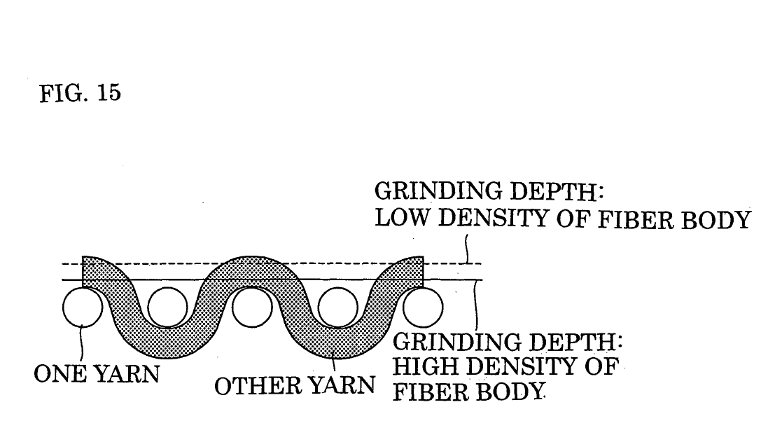

In the case of Examples 5 and 6, wet paper web transfer belts having different average fiber densities were obtained by adjusting the amount of grinding of the same woven fabric. As shown in FIG. 15, the yarns labeled “other yarn” are wound over and below a plurality of yarns labeled “one yarn,” which are arranged nearly parallel to one another in the woven fabric. The amount, that is the density, of the protruding fibers may be adjusted by adjusting the depth of grinding relative to the “other yarns”.

### EXAMPLE 7

In this example, a needle felt was obtained by intertwiningly integrating fiber mats with the outer and inner surfaces respectively of an endless woven fabric by needle punching. Fiber mats comprising a nylon-6 staple fiber with thickness of 6 dtex were used. By heat-pressing the needle felt the density of the staple fibers was brought to about 0.4 g/cm³. Urethane resin was impregnated into the needle felt from its outer surface, and into the middle layer of the woven fabric. The fiber mat on the inner surface of the needle felt was not impregnated with resin. The urethane resin was then cured. The inner and outer surfaces of the needle felt were reversed, and the fiber mat layer which was not impregnated with resin was cut by a slicer to adjust the lengths of its fibers so that the average length of the protruding parts of the fibers was 6.80 mm in the outer surface, that is, the wet paper web side layer, of the belt. The average density of the fibers was about 10,000 pcs/cm².

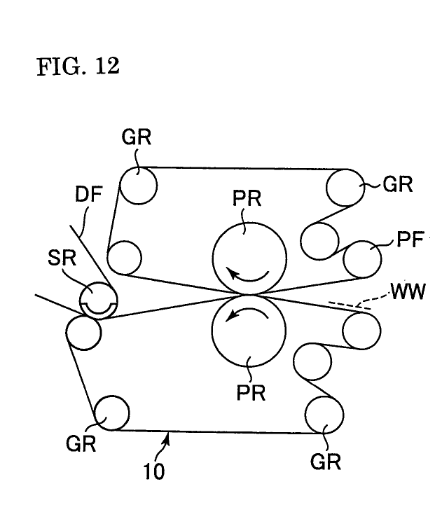

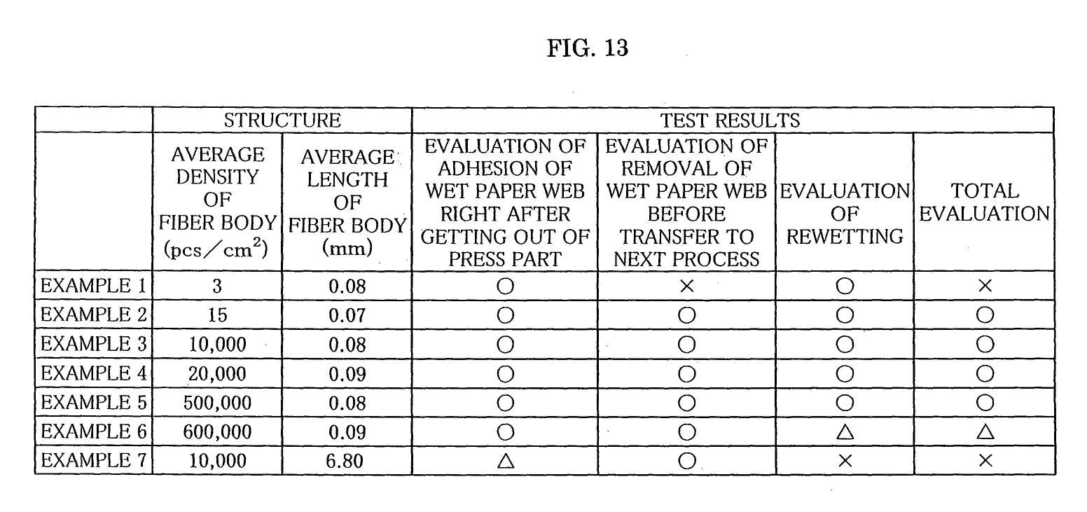

Tests of the wet paper web transfer belts in accordance with the above-described examples were conducted by using the apparatus shown in FIG. 12. This apparatus comprises a pair of press rolls PR forming a press part, a press felt PF pinched by the press rolls, and a wet paper web transfer belt 10. This press felt PF and the wet paper web transfer belt 10 are supported, and maintained at a predetermined tension, by a plurality of guide rolls GR, which rotate along with the rotation of the press rolls. While only a part of a dryer fabric DF is shown in the FIG. 12, the dryer fabric is also endless, and supported and driven by guide rolls (not shown).

A wet paper web WW is placed on the wet paper web transfer belt of this apparatus at the upstream side of the press part. The wet paper web WW passes through the press part, and is transferred to a suction roll SR by the wet paper web transfer belt 10. The wet paper web WW is transferred to the dryer fabric DR by the suction applied by the suction roll SR.

The tests conducted using this apparatus evaluated the performance of the wet paper web transfer belts with regard to (1) adhesion of the wet paper web WW to the wet paper web transfer belt 10 immediately after the wet paper web moves out of the press part; (2) transfer of the wet paper web WW to the dryer fabric DF; and (3) rewetting properties of the wet paper web. Evaluation on the first and second points was conducted by visual observation. As for the third point, the difference between the dryness of the wet paper web WW before it was placed on the test apparatus and its dryness upon arrival at the dryer fabric DF was measured.

The driving speed of the test apparatus was 150 m/min. The pressure applied in the press part was 40 kg/cm. The vacuum at the suction roll SR was 150 mm Hg. A wet paper web WW comprising kraft pulp, having a basis weight of 80 g/m², and a dryness of 38% was used. The press felt PF had a conventional structure, comprising a woven fabric and a batt layer intertwiningly integrated with the woven fabric by needle punching. The press felt PF had a basis weight of 1200 g/m², a batt fiber fineness of 10 dtex, and a density of 0.45 g/cm³.

The results of tests are tabulated in FIG. 13. Excellent results were obtained from Examples 2-5 in all the tests. On the other hand, in the case of Example 1, adhesion of the wet paper web WW was excessively high and the wet paper web WW was not smoothly transferred to the dryer fabric. Example 6 was slightly inferior in that the moisture content of the wet paper web WW after it moved out of the press part was 1-3% higher than in the case of Examples 1-5. In the case of Example 7, the wet paper web did not adhere to the surface of the transfer belt immediately after the wet paper web moved out of a press part, and some oscillation occurred. Furthermore, it was determined that the moisture content of the wet paper web WW, after it moved out of the press part, was 3% or more greater than the moisture content in the case of Examples 1-5.

According to the invention, a fiber body protruding from the surface of a wet paper web side layer of the transfer belt holds water from the wet paper web, and therefore the transfer of a wet paper web by attachment to the transfer belt, and the smoothness of removal of the wet paper web from the transfer belt when the wet paper web is transferred to the next stage of the papermaking process, are improved without decreasing the durability of the transfer belt.

What is claimed is:

1. A wet paper web transfer belt for use in the press part of a closed draw papermaking machine, comprising a base body, a wet paper web side layer having a wet paper web-contacting surface, and a machine side layer, said belt having fibers, parts of which protrude from said web-contacting surface.

2. A wet paper web transfer belt as claimed in claim 1, wherein average length of the protruding parts of said fibers body is between 0.01 and 3 mm.

3. A wet paper web transfer belt as claimed in claim 1, wherein the average density of the protruding parts of said fibers is in the range of 10 to 500,000 fibers/cm².

4. A wet paper web transfer belt as claimed in claim 2, wherein the average density of the protruding parts of said fibers is in the range of 10 to 500,000 fibers/cm².

5. A wet paper web transfer belt as claimed claim 1, wherein said wet paper web side layer has a high molecular weight elastic section, and said fibers are embedded in said high molecular weight elastic section and the protruding parts of said fibers are formed by processing the surface of said high molecular weight elastic section.

6. A wet paper web transfer belt as claimed claim 2, wherein said wet paper web side layer has a high molecular weight elastic section, and said fibers are embedded in said high molecular weight elastic section and the protruding parts of said fibers are formed by processing the surface of said high molecular weight elastic section.

7. A wet paper web transfer belt as claimed claim 3, wherein said wet paper web side layer has a high molecular weight elastic section, and said fibers are embedded in said high molecular weight elastic section and the protruding parts of said fibers are formed by processing the surface of said high molecular weight elastic section.

8. A wet paper web transfer belt as claimed claim 4, wherein said wet paper web side layer has a high molecular weight elastic section, and said fibers are embedded in said high molecular weight elastic section and the protruding parts of said fibers are formed by processing the surface of said high molecular weight elastic section.

9. A wet paper web transfer belt as claimed in claim 1, wherein said wet paper web side layer has a high molecular weight elastic section and said protruding parts of said fibers are caused to protrude by processing the surface of a belt-shaped body placed on said high molecular weight elastic section.

10. A wet paper web transfer belt as claimed in claim 2, wherein said wet paper web side layer has a high molecular weight elastic section and said protruding parts of said fibers are caused to protrude by processing the surface of a belt-shaped body placed on said high molecular weight elastic section..

11. A wet paper web transfer belt as claimed in claim 3, wherein said wet paper web side layer has a high molecular weight elastic section and said protruding parts of said fibers are caused to protrude by processing the surface of a belt-shaped body placed on said high molecular weight elastic section.

12. A wet paper web transfer belt as claimed in claim 4, wherein said wet paper web side layer has a high molecular weight elastic section and said protruding parts of said fibers are caused to protrude by processing the surface of a belt-shaped body placed on said high molecular weight elastic section.
